(19) United States
(12) Patent Application Publication
(10) Pub. No.: US 2014/0015775 A1
(43) Pub. Date: Jan. 16, 2014

(54) TOUCH MODULE WITH LIQUID CRYSTAL LENS AND DISPLAY APPARATUS HAVING THE SAME

(71) Applicant: HANNSTAR DISPLAY CORP., NEW TAIPEI CITY (TW)

(72) Inventors: HSU-HO WU, TAINAN CITY (TW); CHIA-HUA YU, NEW TAIPEI CITY (TW); KUN-CHENG LEE, TAINAN CITY (TW); I-FANG WANG, CHANGHUA COUNTY (TW); FENG-WEEI KUO, PINGTUNG COUNTY (TW)

(73) Assignee: HANNSTAR DISPLAY CORP., New Taipei City (TW)

(21) Appl. No.: 13/860,691

(22) Filed: Apr. 11, 2013

(30) Foreign Application Priority Data
Jul. 16, 2012 (CN) 201210246345.6

(51) Int. Cl. G06F 3/041

(52) U.S. Cl. CPC G06F 3/041
USPC 345/173

(57) ABSTRACT

The present disclosure provides a touch module with liquid crystal lens that includes only two transparent substrates, a touch sensing conductive pattern, a liquid crystal light valve conductive pattern, a shielding conductive layer, an insulating layer and a liquid crystal layer. The touch sensing conductive pattern is formed on the lower surface of the first transparent substrate. The liquid crystal light valve conductive pattern is formed on the upper surface of the second transparent substrate. The shielding conductive layer is formed under the first transparent substrate. The insulating layer is formed between the first transparent substrate and the shielding conductive layer and covers the touch sensing conductive pattern to insulate the touch sensing conductive pattern from the shielding conductive layer. The liquid crystal layer is positioned between the shield conductive layer and the second transparent substrate.

### CROSS REFERENCE TO RELATED APPLICATION

This application claims the priority benefit of China Patent Application Serial Number 201210246345.6 filed Jul. 16, 2012, the full disclosure of which is incorporated herein by reference.

### BACKGROUND

1. Technical Field

The disclosure relates to a touch module and a display apparatus having the touch module, and more particularly, to a touch module with liquid crystal lens and a display apparatus having the touch module.

2. Description of the Related Art

Today many of cell phones and almost all of tablet computers are provided with touch sensing function. Some of these devices are further provided with stereoscopic display function.

Referring to FIG. 1, a conventional display apparatus 100 with function of touch sensing and stereoscopic display at least includes a display 110, a liquid crystal lens unit 120 and a touch panel 130. A polarizer 142 is positioned on the display 110. The liquid crystal lens unit 120 is bonded with the polarizer 142 by an adhesive material 144, such as optical clear adhesive (OCA) or double coated tape. The liquid crystal lens unit 120 is configured to make the images generated by the display 110 stereoscopic and has an upper substrate 122, a lower substrate 124 and a liquid crystal layer 125 sandwiched between the upper and lower substrates 122, 124. A plurality of electrodes 126 is formed on a lower surface of the upper substrate 122. A continuous and non-patterned electrode layer 128 is formed on an upper surface of the lower substrate 124 and functions as a counter electrode of the electrodes 126. The touch panel 130 is configured to sense touches thereon. The touch panel 130 is positioned above the liquid crystal lens unit 120 and includes a cover lens 132 and a substrate 134. A conductive pattern 136 is formed on a lower surface of the cover lens 132 to determine the positions of touches on the cover lens 132. A shielding conductive layer 138 is formed on an upper surface of the substrate 134 to shield the conductive pattern 136 from electromagnetic interference. In addition, an insulating layer 135 is positioned between the conductive pattern 136 and shielding conductive layer 138 to insulate the conductive pattern 136 and the shielding conductive layer 138 from each other.

The above display apparatus 100 includes additional the liquid crystal lens unit 120 and touch panel 130, and therefore is thicker and heavier than common displays.

Accordingly, there exists a need to provide a solution to solve the aforesaid problems.

### SUMMARY

The present disclosure provides a touch module with liquid crystal lens that is more lightweight and smaller than conventional ones.

In first embodiment, the touch module with liquid crystal lens according to the present disclosure includes only two transparent substrates, a touch sensing conductive pattern, a liquid crystal light valve conductive pattern, a shielding conductive layer, an insulating layer and a liquid crystal layer. The only two transparent substrates are defined as a first transparent substrate and a second transparent substrate, respectively. The first transparent substrate is positioned above the second transparent substrate. The touch sensing conductive pattern is formed on the lower surface of the first transparent substrate. The liquid crystal light valve conductive pattern is formed on the upper surface of the second transparent substrate. The shielding conductive layer is formed under the first transparent substrate. The insulating layer is formed between the first transparent substrate and the shielding conductive layer and covers the touch sensing conductive pattern to insulate the touch sensing conductive pattern from the shielding conductive layer. The liquid crystal layer is positioned between the shield conductive layer and the second transparent substrate.

In second embodiment, the touch module with liquid crystal lens according to the present disclosure includes only two transparent substrates, a touch sensing conductive pattern, a liquid crystal light valve conductive pattern, a shielding conductive layer, an insulating layer and a liquid crystal layer. The only two transparent substrates are defined as a first transparent substrate and a second transparent substrate, respectively. The first transparent substrate is positioned above the second transparent substrate. The touch sensing conductive pattern is formed on the lower surface of the first transparent substrate. The shielding conductive layer is formed on the upper surface of the second transparent substrate. The liquid crystal light valve conductive pattern is formed under the first transparent substrate. The insulating layer is formed between the first transparent substrate and the liquid crystal light valve conductive pattern and covers the touch sensing conductive pattern to insulate the touch sensing conductive pattern from the liquid crystal light valve conductive pattern. The liquid crystal layer is positioned between the shield conductive layer and the insulating layer.

The present disclosure further provides a display apparatus with the above touch module in the first embodiment. The touch module with liquid crystal lens is positioned above a display.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is a schematic view of a conventional display apparatus with function of touch sensing and stereoscopic display.

FIG. 2 is a schematic view of the touch module with liquid crystal lens according to the first embodiment of the present disclosure.

FIG. 3 is a schematic view of the touch module with liquid crystal lens according to the second embodiment of the present disclosure.

FIG. 4 is a schematic view of the display apparatus according to the first embodiment of the present disclosure.

FIG. 5 is a schematic view of the display apparatus according to the second embodiment of the present disclosure.

FIG. 6 is a schematic view of the display apparatus according to the third embodiment of the present disclosure.

FIG. 7 is a schematic view of the display apparatus according to the fourth embodiment of the present disclosure.

FIG. 8 is a schematic view of the display apparatus according to the fifth embodiment of the present disclosure.

FIG. 9 is a schematic view of the display apparatus according to the sixth embodiment of the present disclosure.

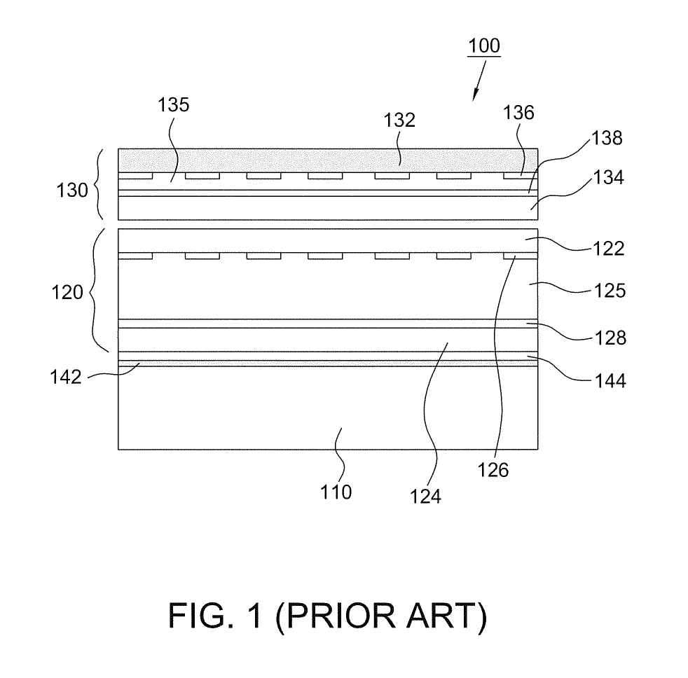

### DETAILED DESCRIPTION OF THE PREFERRED EMBODIMENT

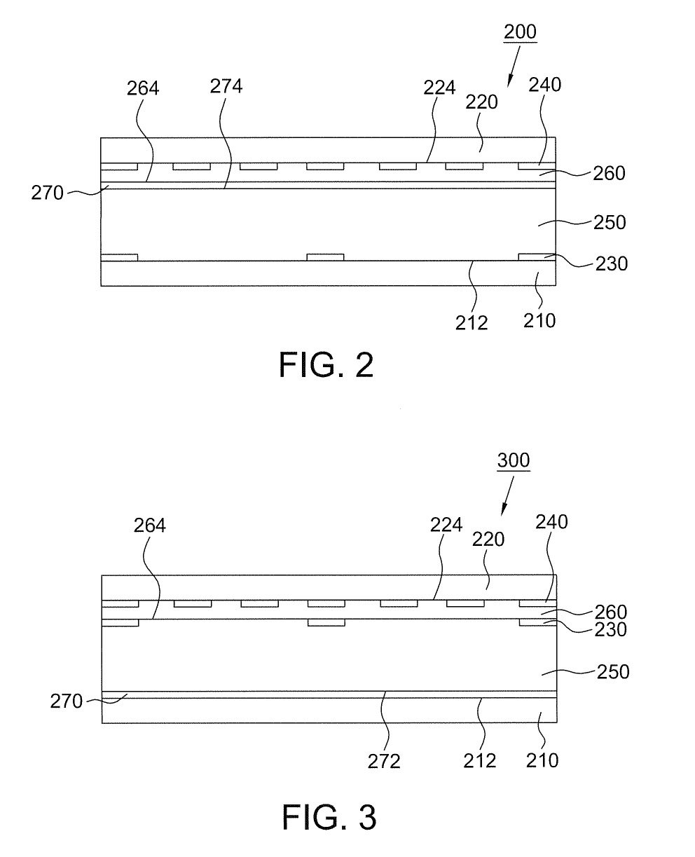

Referring to FIG. 2, the touch module 200 with liquid crystal lens according to the first embodiment of the present disclosure includes only two transparent substrates 210, 220 and a liquid crystal layer 250. The transparent substrate 210 may be a glass substrate and a liquid crystal light valve conductive pattern 230 is formed on an upper surface 212 of the transparent substrate 210. The liquid crystal light valve conductive pattern 230 may be made of transparent indium tin oxide (ITO). The transparent substrate 220 forms a cover lens 220 and is positioned above the transparent substrate 210. A touch sensing conductive pattern 240 made of transparent indium tin oxide is formed on a lower surface 224 of the transparent substrate 220. An insulating layer 260 is formed under the transparent substrate 220 to cover the touch sensing conductive pattern 240. In addition, a shielding conductive layer 270 made of transparent indium tin oxide is formed on a lower surface 264 of the insulating layer 260. The shielding conductive layer 270 is continuous and has no gap to expose the insulating layer 260. The liquid crystal layer 250 is positioned between a lower surface 274 of the shielding conductive layer 270 and the upper surface 212 of the transparent substrate 210.

Referring to FIG. 3, the touch module 300 with liquid crystal lens according to the second embodiment of the present disclosure includes all the elements of the touch module 200 described in the first embodiment, where identical reference numbers have been used when designating substantially identical elements that are common to the figures. The arrangements of the elements of the touch module 300 are substantially the same as the arrangements of the elements of the touch module 200. However, in this embodiment the liquid crystal light valve conductive pattern 230 is formed on the lower surface 264 of the insulating layer 260 and the shielding conductive layer 270 is formed on the upper surface 212 of the transparent substrate 210. Furthermore, the liquid crystal layer 250 is positioned between the lower surface 264 of the insulating layer 260 and an upper surface 272 of the shielding conductive layer 270 in this embodiment.

According to the touch modules 200, 300 of the present disclosure, the touch sensing conductive patterns 240 formed on the lower surfaces 224 of the transparent substrates 220 are configured to sense touches of users' fingers on the transparent substrates 220. The insulating layers 260 are configured to insulate the touch sensing conductive patterns 240 and the shielding conductive layers 270 from each other, and the shielding conductive layers 270 are configured to shield the touch sensing conductive patterns 240 from the electromagnetic interferences caused by the elements positioned below. In addition, the shielding conductive layers 270 may function as counter electrodes of the liquid crystal light valve conductive patterns 230. The liquid crystal light valve conductive patterns 230 are configured to control the alignment of the liquid crystal molecules in the liquid crystal layers 250 so as to make the images generated by a display stereoscopic.

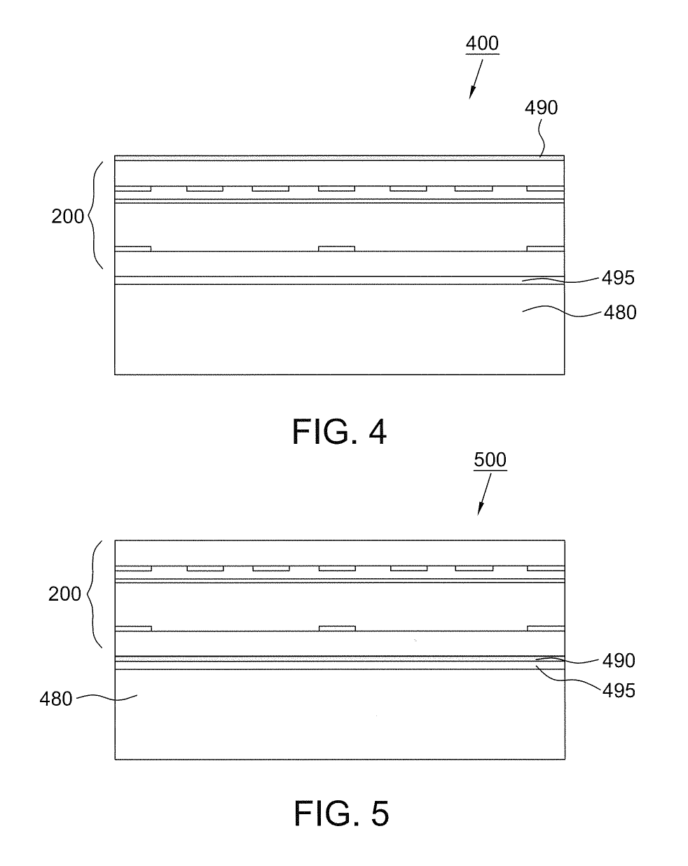

Referring to FIG. 4, the display apparatus 400 according to the first embodiment of the present disclosure includes the touch module 200 of FIG. 2, a display 480 and a polarizer 490. The touch module 200 is positioned above the display 480 and these two elements are bonded together with an adhesive material 495, such as optical clear adhesive or double coated tape. The polarizer 490 is positioned above the touch module 200.

Referring to FIG. 5, the display apparatus 500 according to the second embodiment of the present disclosure also includes the touch module 200, display 480 and polarizer 490. However, according to the display apparatus 500 in this embodiment the polarizer 490 is positioned above the display 480 and these two elements are bonded together with the adhesive material 495. The touch module 200 is positioned above the polarizer 490.

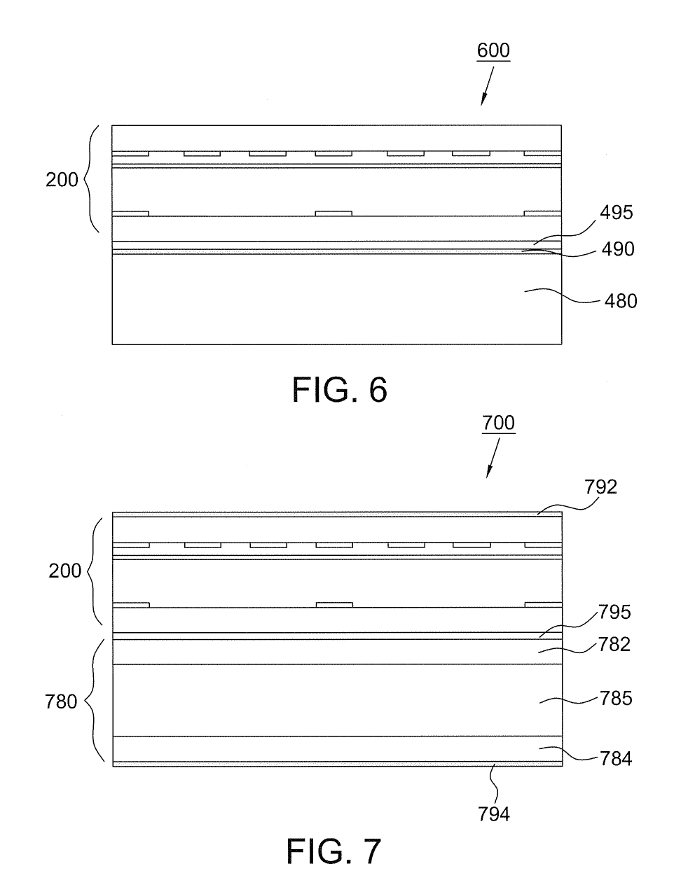

Referring to FIG. 6, the display apparatus 600 according to the third embodiment of the present disclosure also includes the touch module 200, display 480 and polarizer 490. However, according to the display apparatus 600 in this embodiment the polarizer 490 is positioned above the display 480. The touch module 200 is positioned above the polarizer 490 and these two elements are bonded together with the adhesive material 495.

According to the display apparatus 400, 500, 600 of the present disclosure, the displays 480 may be any types of displays that may function well without equipping with any of polarizers. For example, the displays 480 may be cathode ray tube (CRT) displays, plasma displays or organic light-emitting diode (OLED) displays. In addition, the polarizers 490 may be located basically at any positions above the displays 480. For example, the polarizers 490 may be positioned above the touch modules 200 or between the touch modules 200 and the displays 480. The touch modules 200 not only sense touches on the transparent substrates 220 but make the images generated by the displays 480 stereoscopic with the function of the polarizers 490.

Referring to FIG. 7, the display apparatus 700 according to the fourth embodiment of the present disclosure includes the touch module 200 of FIG. 2, a liquid crystal display 780 and two polarizers 792, 794. The liquid crystal display 780 at least includes a liquid crystal layer 785 sandwiched between an upper transparent substrate 782 and a lower transparent substrate 784. The polarizer 794 is positioned under the lower transparent substrate 784. The touch module 200 is positioned above the liquid crystal display 780 and these two elements are bonded together with an adhesive material 795, such as optical clear adhesive or double coated tape. The polarizer 792 is positioned above the touch module 200.

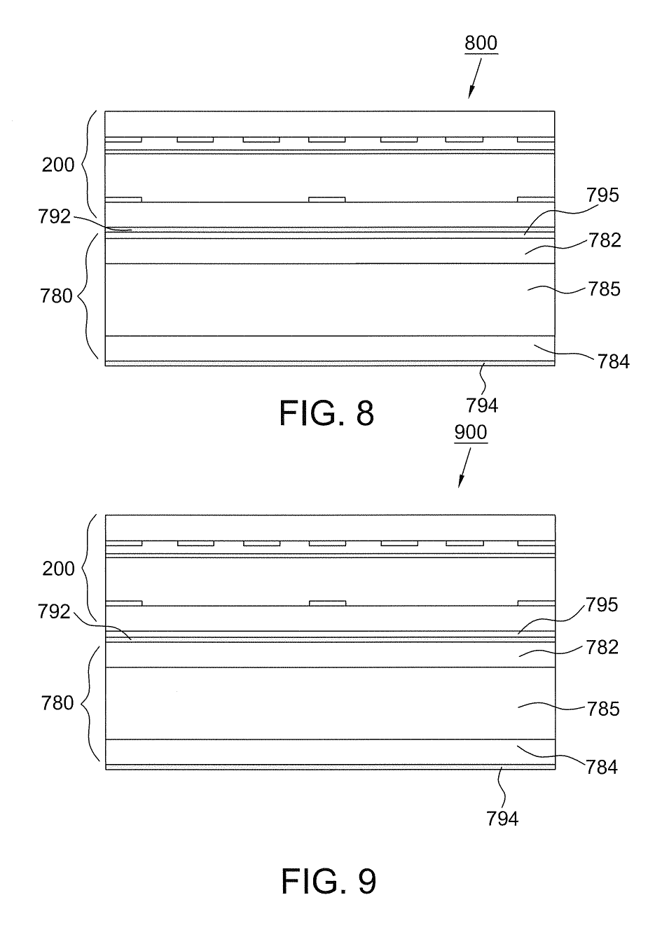

Referring to FIG. 8, the display apparatus 800 according to the fifth embodiment of the present disclosure also includes the touch module 200, liquid crystal display 780 and polarizers 792, 794. The polarizer 794 is also positioned under the lower transparent substrate 784 of the liquid crystal display 780. However, according to the display apparatus 800 in this embodiment, the polarizer 792 is positioned above the liquid crystal display 780 and these two elements are bonded together with the adhesive material 795. The touch module 200 is positioned above the polarizer 792.

Referring to FIG. 9, the display apparatus 900 according to the sixth embodiment of the present disclosure also includes the touch module 200, liquid crystal display 780 and polarizers 792, 794. The polarizer 794 is also positioned under the lower transparent substrate 784 of the liquid crystal display 780. However, according to the display apparatus 900 in this embodiment, the polarizer 792 is positioned above the liquid crystal display 780. The touch module 200 is positioned above the polarizer 792 and these two elements are bonded together with the adhesive material 795.

According to the display apparatus 700, 800, 900 of the present disclosure, the liquid crystal displays 780 may generate images in the existence of the polarizers 792, 794. The touch modules 200 not only sense touches on the transparent substrates 220 but make the images generated by the liquid crystal displays 780 stereoscopic with the function of the polarizers 792. In addition, the polarizers 792 may be located basically at any positions above the liquid crystal displays 780. For example, the polarizers 792 may be positioned above the touch modules 200 or between the touch modules 200 and the liquid crystal displays 780.

According to the present disclosure, the liquid crystal lens units 120 are integrated with the touch panels 130 to form the touch module 200 or touch module 300 of the present disclosure. There is no need to configure any transparent substrates between the transparent substrates 210 and 220. Therefore, the thickness and weight of the touch modules 200, 300 are smaller than the combinations of the conventional liquid crystal lens unit 120 and touch panel 130 because of the reduction of two transparent substrates. The modules 200, 300 are very in favor of use in mobile display devices.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A touch module with liquid crystal lens, comprising:
only two transparent substrates defined as a first transparent substrate and a second transparent substrate, respectively, the first transparent substrate being positioned above the second transparent substrate, the first transparent substrate having an upper surface and a lower surface, the second transparent substrate having an upper surface and a lower surface;
a touch sensing conductive pattern formed on the lower surface of the first transparent substrate;
a liquid crystal light valve conductive pattern formed on the upper surface of the second transparent substrate;
a shielding conductive layer formed under the first transparent substrate;
an insulating layer formed between the first transparent substrate and the shielding conductive layer, the insulating layer covering the touch sensing conductive pattern to insulate the touch sensing conductive pattern from the shielding conductive layer; and
a liquid crystal layer positioned between the shield conductive layer and the second transparent substrate.

2. A display apparatus, comprising:
a display; and
a touch module with liquid crystal lens as claimed in claim 1, disposed on the display.

3. The display apparatus as claimed in claim 2, wherein the touch module with liquid crystal lens is bonded with the display with an adhesive material.

4. The display apparatus as claimed in claim 2, further comprising a first polarizer positioned above the display.

5. The display apparatus as claimed in claim 4, wherein the first polarizer is positioned above the touch module with liquid crystal lens.

6. The display apparatus as claimed in claim 4, wherein the first polarizer is positioned between the display and the touch module with liquid crystal lens.

7. The display apparatus as claimed in claim 6, wherein the first polarizer is bonded with the display with an adhesive material.

8. The display apparatus as claimed in claim 6, wherein the first polarizer is bonded with the touch module with liquid crystal lens with an adhesive material.

9. The display apparatus as claimed in claim 2, wherein the display is one selected from the group consisting of cathode ray tube (CRT) display, plasma display, organic light-emitting diode (OLED) display, and liquid crystal display.

10. The display apparatus as claimed in claim 4, further comprising a second polarizer positioned under the display.

11. A touch module with liquid crystal lens, comprising:
only two transparent substrates defined as a first transparent substrate and a second transparent substrate, respectively, the first transparent substrate being positioned above the second transparent substrate, the first transparent substrate having an upper surface and a lower surface, the second transparent substrate having an upper surface and a lower surface;
a touch sensing conductive pattern formed on the lower surface of the first transparent substrate;
a shielding conductive layer formed on the upper surface of the second transparent substrate;
a liquid crystal light valve conductive pattern formed under the first transparent substrate;
an insulating layer formed between the first transparent substrate and the liquid crystal light valve conductive pattern, the insulating layer covering the touch sensing conductive pattern to insulate the touch sensing conductive pattern from the liquid crystal light valve conductive pattern; and
a liquid crystal layer positioned between the shield conductive layer and the insulating layer.

12. A display apparatus, comprising:
a display; and
a touch module with liquid crystal lens as claimed in claim 11, disposed on the display.

13. The display apparatus as claimed in claim 12, wherein the touch module with liquid crystal lens is bonded with the display with an adhesive material.

14. The display apparatus as claimed in claim 12, further comprising a first polarizer positioned above the display.

15. The display apparatus as claimed in claim 14, wherein the first polarizer is positioned above the touch module with liquid crystal lens.

16. The display apparatus as claimed in claim 14, wherein the first polarizer is positioned between the display and the touch module with liquid crystal lens.

17. The display apparatus as claimed in claim 16, wherein the first polarizer is bonded with the display with an adhesive material.

18. The display apparatus as claimed in claim 16, wherein the first polarizer is bonded with the touch module with liquid crystal lens with an adhesive material.

19. The display apparatus as claimed in claim 12, wherein the display is one selected from the group consisting of cathode ray tube (CRT) display, plasma display, organic light-emitting diode (OLED) display, and liquid crystal display.

20. The display apparatus as claimed in claim 14, further comprising a second polarizer positioned under the display.
